(19) United States
(12) Patent Application Publication
(10) Pub. No.: US 2005/0004814 A1
(43) Pub. Date: Jan. 6, 2005

(54) Method and system for distributing medical safety information

(76) Inventor: Jonathan H. Seltzer, Philadelphia, PA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 10/834,401

(22) Filed: Apr. 29, 2004

Related U.S. Application Data
(60) Provisional application No. 60/466,331, filed on Apr. 29, 2003.

(51) Int. Cl. G06F 17/60; G06F 7/00; G06F 17/00

(52) U.S. Cl. 705/2; 707/104.1

(57) ABSTRACT

A method and system for distributing medical safety information is disclosed. A first database containing medical safety information and a second database containing identification and preference data relating to a plurality of health care system participants are maintained by the system. One or more health care system participants are selected from the second database, and medical safety information is identified in the first database that corresponds to the preference data of the selected health care system participants. At least a portion of the medical safety information is transmitted to the selected health care system participants. Feedback information indicative of a measure of the efficacy of the distribution of the medical safety information is received. The feedback information is used to automatically determine whether to distribute additional medical safety information to one or more of the health care system participants.

### CROSS-REFERENCE TO RELATED APPLICATION

This patent application claims priority to, and incorporates by reference in its entirety, U.S. Provisional Patent Application No. 60/466,331, entitled “Risk Reduction Relationship Management and Compliance System for Medication Usage” and filed Apr. 29, 2003.

### TECHNICAL FIELD

The present invention is directed to an improved clinical information system for providing and continuously improving the provision of information used to reduce the risk associated with drugs and/or medical devices. The present invention is further directed at effectively communicating medical safety information among health care providers, patients, health care payers, medical drug and device manufacturers and/or other health care entities. The disclosed methods and systems maintain a medical safety information database and update the database based on health care provider and/or patient feedback information. Embodiments of the invention may also be directed towards the acquisition and provision of compliance reports for Food and Drug Administration risk management requirements.

### BACKGROUND

The health care delivery system in the United States is decentralized and fragmented. Rigidly defined areas of specialization and decentralized databases of information provide impediments to an individual health care provider having a complete medical history of a patient. For example, if a patient sees multiple providers, complete information is generally not available to each provider under the current system. As a result, it is much more likely that something will go wrong because of the lack of coordination. In addition, the provision of care to patients by a collection of loosely affiliated organizations and providers impedes the implementation of clinical information systems that can provide timely access to complete patient information.

Adverse drug events, such as patient reactions to prescribed medications or treatments, are the eighth leading cause of death in the United States according to a report published in 1999 by the Institute of Medicine. As such, adverse drug events kill more people than breast cancer, AIDS, highway accidents or workplace accidents. Many of these events are preventable provided that proper information is transmitted to and understood by health care professionals. The present health care infrastructure impedes the distribution of such information.

In addition, medication error has played a significant role in the development of initiatives by the Food and Drug Administration (“FDA”). In accordance with Section VII of the Prescription Drug User Fee Act III (“PDUFA III”) Reauthorization Performance Goals and Procedures, the FDA must develop guidance for the medical industry on development, implementation and evaluation of drug and biological product risk management programs. Risk management is the overall and continuing process of minimizing risks throughout a product's lifecycle to optimize its benefit/risk-balance. Risk management includes the continual-process of (1) learning about and interpreting a product's benefits and risks, (2) designing and implementing interventions to minimize a product's risks, (3) evaluating interventions in light of new knowledge that is acquired over time, and (4) revising interventions when appropriate. Risk information emerges continuously throughout a product's lifecycle, during both the investigation and marketing phases through both labeled and off-label uses.

Conventionally, a number of approaches have been used to distribute medical safety information. Generally, the approaches can be categorized in one of three classes: (1) one-way communication, (2) educational material focused on prevention, and (3) epidemiologic or similar types of statistical analysis. Typically, such approaches are single health care provider or organization based detection and reporting systems. Accordingly, information is centrally located within a provider or organization and may not be transferable between organizations or providers. Exemplary approaches are presented below.

One-way communication may include correspondence from a drug manufacturer to health care providers (e.g., physicians, pharmacists, nurses, etc.) alerting them to new medical safety information or information related to the safe use of the manufacturer's products. Typically, the information may come in the form of a letter or leaflet.

Under the Voluntary Adverse Event Reporting (Medwatch) System, the FDA collects information from health care providers or patients submitted to the FDA on a voluntary basis. Such information may pertain to adverse drug events, manufacturing defects, and the like.

The Pediatric Adverse Drug Event and Reaction Reporting System is a national computerized reporting program among a network of hospitals that is designed to standardize the collection and analysis of adverse drug events and adverse drug reactions in children. The program encourages the identification and reporting of adverse drug events and reactions in children and the application of analysis results to prevent such events and reactions and to improve patient outcomes.

The Vaccine Adverse Event Reporting System (VAERS) is a national vaccine safety surveillance program co-sponsored by the Center for Disease Control and Prevention (“CDC”) and the FDA. VAERS collects and analyzes information from reports of adverse events following immunization. By monitoring such events, VAERS helps to identify new safety concerns related to immunization.

Each of the above-listed approaches to distributing medical safety information suffers from similar problems. First, each of the approaches depends upon voluntary reporting, education and analysis. For example, the FDA Medwatch adverse event reporting system is a voluntary reporting system. If a problem is identified with a medication, the health care providers must seek out and read about the problem. Likewise, patients must seek out information pertaining to whether adverse drug events have occurred with their medications. Educational programs and analysis activities sponsored by the program are likewise voluntary.

Furthermore, each of the above approaches is passive in nature. The health care provider or patient has little involvement in the process of risk reduction for medications since the provider or the patient merely receives information. Activity commensurate with receipt of such information is not required.

In addition, none of the approaches provide more than one-way communication. Since feedback is not possible under the current systems, the effectiveness of communication strategies is difficult to measure. For example, in the case of “Dear Healthcare Provider” letters or patient safety pamphlets, little evidence exists that-the intended-recipients of such information sources even read the information. Determining the effectiveness of such communication methods is even more difficult.

Moreover, current risk reduction efforts are targeted solo efforts for providing notification to the health care provider or patient. Accordingly, such information is presented to the health care provider or patient in a fragmented way. Since many different mechanisms exist for providing such information, the intended recipient must actively monitor a plurality of sources in order to receive adequate knowledge regarding drug safety information, if such information is even available to a particular interested party. For example, in the case of a manufactured pharmaceutical product, current systems may provide information from the manufacturer to the physician, but may not provide a way to transmit information from the physician to the patient or from either the physician or patient to the manufacturer. As such, the ability to fully transmit information is not provided.

Another problem with conventional approaches is that the reporting procedures are not consistent over time. It is well known that the reporting of drug safety information peaks near the time a new medical product is launched because the physician's interest and general awareness of the product is high. Consequently, current risk reduction systems are reliant on the bulk of the information being provided in a relatively short period of the product's life cycle. Long-term side effects may not be discovered or adequately disclosed as a result.

Yet another problem with conventional approaches is that they imprecisely distribute information. It is difficult to measure the success of current efforts in the field because risk reduction metrics generally cannot assess current approaches. For example, educational programs can measure program success, but they are not tied to risk reduction metrics. Similarly, “Dear Healthcare Provider” letters carry no success metric. Since safety reporting is spontaneous, voluntary, and only communicates one-way, no sample population exists from which the rate of adverse events can be calculated. Accordingly, the efficacy of risk reduction approaches cannot be adequately measured.

What is needed is a method and system for providing a centralized repository for clinical medical safety information.

A further need exists for a method and system for providing such a repository where information is accessible at the time medications are prescribed or filled.

A further need exists for a method and system for providing drug safety information reporting that provides active feedback information from the health care provider or patient to the drug or medical device manufacturer.

A further need exists for a method and system for providing and updating medical safety information on an on-going basis.

A further need exists for a method and system for providing medical safety information that provides an ability to measure the effectiveness of the provision and application of such information.

A further need exists for a method and system that provides the patient with safety information that their physician authorizes.

A further need exists for a system that provides the health care provider with the knowledge that his or her patients have been adequately notified of potential safety concerns.

A still further need exists for the health care provider to learn and provide the most effective means of communication and patient comprehension.

The present invention is directed to solving one or more of the above-listed problems.

### SUMMARY

Before the present methods and systems are described, it is to be understood that this invention is not limited to the particular methodologies and systems described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a,” “an,” and “the” include plural references unless the context clearly dictates otherwise. Thus, for example, reference to a “database” is a reference to one or more databases and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments of the present invention, the preferred methods, materials, and devices are now described. All publications mentioned herein are incorporated by reference. Nothing herein is to be construed as an admission that the invention is not entitled to antedate such disclosure by virtue of prior invention.

In an embodiment, a method for distributing medical safety information includes maintaining a first database containing medical safety information, maintaining a second database containing identification and preference data relating to a plurality of health care system participants, selecting one or more health care system participants from the second database, identifying medical safety information in the first database corresponding to the preference data of the selected health care system participants, distributing at least a portion of the identified medical safety information to the selected health care system participants, receiving feedback information indicative of a measure of performance for the distributing step, and automatically determining, based on the feedback information, whether to distribute additional medical safety information to one or more of the selected health care system participants. In an embodiment, the preference data comprises an identifier for a medical product. In an embodiment, the health care system participants include one or more of health care providers, patients, and health care organizations. In an embodiment, selecting one or more health care participants includes selecting one or more health care participants based on the preference data. The method may further include generating one or more compliance reports based on the feedback information. The preference data may be obtained from a consent form or generated based on feedback information. In an embodiment, distributing at least a portion of the identified medical safety information includes distributing at least a portion of the identified medical safety information via one or more of a telephone system, a computer network, and a physical mail system. In an embodiment, the identified medical safety information includes one or more of information from a manufacturer of a medical product, information regarding a clinical study pertaining to the medical product, precautionary information pertaining to the medical product, and one or more reported adverse reactions.

In an embodiment, a system for distributing medical safety information includes a processor, a first database containing medical safety information, a second database containing identification and preference data relating to a plurality of health care system participants, and a computer-readable storage medium. The computer-readable storage medium contains one or more programming instructions for performing a method of distributing medical safety information including selecting one or more health care system participants from the second database, identifying medical safety information in the first database corresponding to the preference data of the selected health care system participants, distributing at least a portion of the identified medical safety information to the selected health care system participants, receiving feedback information indicative of a measure of performance for the distributing step, and automatically determining, based on the feedback information, whether to distribute additional medical safety information to one or more of the selected health care system participants. In an embodiment, the preference data includes an identifier for a medical product. In an embodiment, the health care system participants include one or more of health care providers, patients, and health care organizations. In an embodiment, selecting one or more health care participants includes selecting one or more health care participants based on the preference data. In an embodiment, the computer-readable storage medium further includes one or more programming instructions for generating one or more compliance reports based on the feedback information. The preference data may be obtained from a consent form or generated based on feedback information. In an embodiment, distributing at least a portion of the identified medical safety information includes distributing at least a portion of the identified medical safety information via one or more of a telephone system, a computer network, and a physical mail system. In an embodiment, the identified medical safety information includes one or more of information from a manufacturer of a medical product, information regarding a clinical study-pertaining to-the medical product, precautionary information pertaining to the medical product, and one or more reported adverse reactions.

Various aspects and applications of the present invention will become apparent to the skilled artisan upon consideration of the brief description of the figures and the detailed description of the invention which follows.

### BRIEF DESCRIPTION OF THE DRAWINGS

Aspects, features, benefits and advantages of the embodiments of the present invention will be apparent with regard to the following description, appended claims and accompanying drawings where:

FIG. 1 depicts an interconnection diagram between an exemplary medical safety information system and individuals requesting feedback according to an embodiment.

FIG. 2 depicts an exemplary health care provider request form according to an embodiment.

FIG. 3 depicts an exemplary patient request form according to an embodiment.

FIG. 4 depicts an exemplary method for enrolling a health care provider with a medical safety information system according to an embodiment.

FIG. 5 depicts an exemplary method for enrolling a patient with a medical safety information system according to an embodiment.

FIG. 6 depicts an exemplary method for matching medical safety information content with a health care provider or patient request for information according to an embodiment.

FIG. 7 depicts an exemplary email containing medical safety information according to an embodiment.

FIG. 8 depicts an exemplary method of providing feedback to the medical safety information system from a health care provider or patient according to an embodiment.

FIG. 9 depicts an exemplary method of updating the medical safety information system based on received feedback according to an embodiment.

FIG. 10A depicts an exemplary entity relationship diagram for a medical safety information system according to an embodiment.

FIGS. 10B-D depict exemplary data types associated with entities in FIG. 10A according to an embodiment.

### TECHNICAL DESCRIPTION

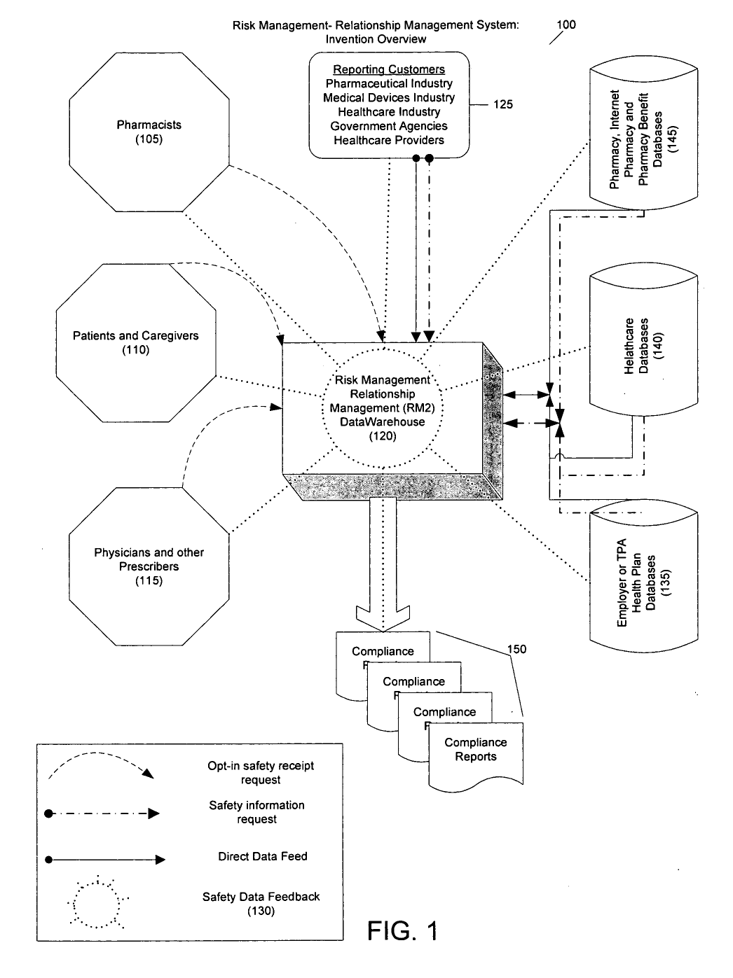

FIG. 1 depicts an interconnection diagram between an exemplary medical safety information system and individuals requesting feedback according to an embodiment. The interconnection diagram provides an overview of a system for continuously improving the management of risk reduction relationships and generating compliance reports 100. Participants in the health care system, such as pharmacists 105, patients and/or caregivers 110, and physicians and other prescribers 115, may have the opportunity to choose to receive medical safety information. Such medical safety information may be requested via consent forms or via other procedures.

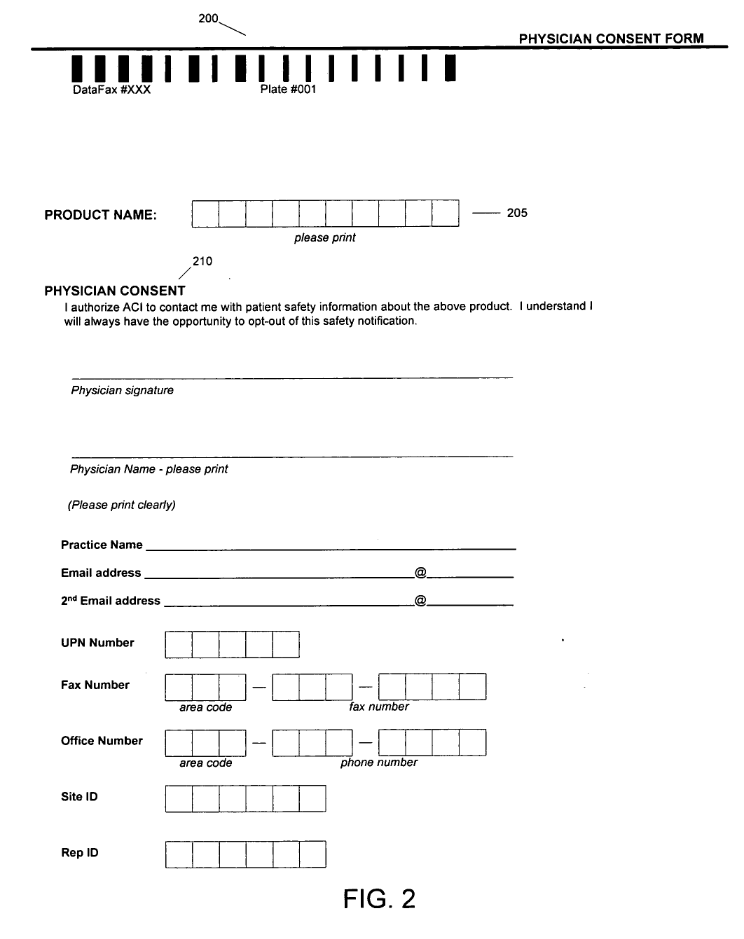

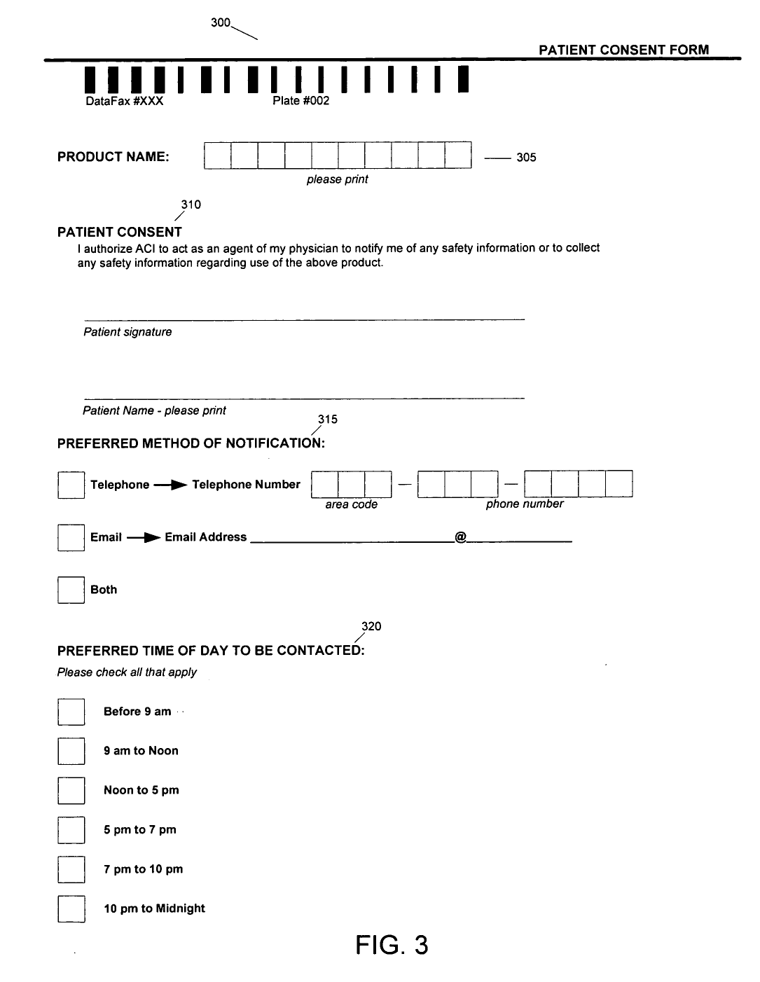

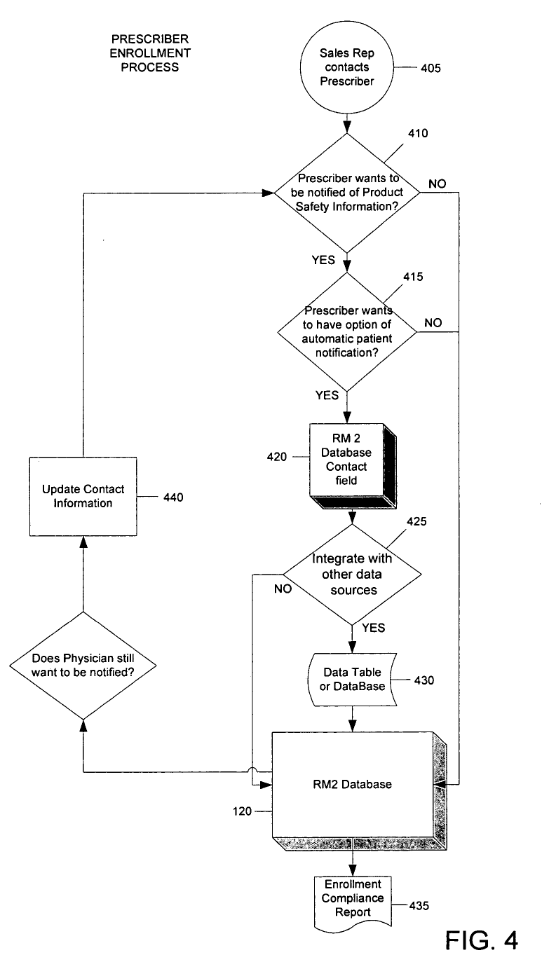

Referring to FIG. 2, a physician consent form 200 may request that the physician or other prescribing individual provide contact information 210 and one or more products 205 for which the physician would like to receive information. Referring to FIG. 3, a patient consent form 300 may request that the patient provide contact information 310, one or more products 305 for which the patient would like to receive information, a indication of a preferred method of notification 315 and an indication of a preferred time for notification 320. The physician and/or patient may request, receive and/or return the appropriate consent form via mail, telephone, facsimile, email or any other communication method.

Referring back to FIG. 1, the information from a consent form may be entered into a Risk Management Relationship Management (“RM2”) Data Warehouse 120. As medical safety information pertaining to particular drugs or medical devices is received from reporting customers 125, such as drug manufacturers or others in the pharmaceutical industry, medical device manufacturers, health care payers, health care providers or organizations and government agencies, the information may be entered into the RM2 database 120. The information may then be distributed to individuals requesting such information based on the data received from the consent forms. One or more of the health care organizations, health care payers, health care providers, and the medical drug and device manufacturers may request feedback 130 from one or more of the health care organizations, health care providers and patients regarding the use of the medical drug or device. The RM2 database 120 may compile metrics for the communication based on, for example, such feedback. The RM2 database 120 may then combine the compiled metrics with data from other data sources, such as employer health plan databases 135, healthcare databases 140, and/or pharmacy, internet pharmacy, and pharmacy benefit databases 145, in order to provide compliance and operational activity reports 150 documenting the notification and activity of the target audience.

FIG. 4 depicts an exemplary method for enrolling a health care provider with a medical safety information system according to an embodiment. Initially, a representative, such as a pharmaceutical sales representative, may contact 405 a physician or other prescriber. The physician may be queried 410 as to whether he or she wants to be notified of medical safety information regarding one or more products. If the physician elects to be notified, a physician consent form, such as 200, may be completed to opt-in to receiving such information. Additionally, the representative may query 415 the physician as to whether the physician would prefer the option of automatically identifying his or her patients and receiving compliance reports. If the physician elects the option, the information may be obtained 420 and integrated with other data sources 425, if any, to create a database 430. The database 430 may be imported into the RM2 database 120. The RM2 database 120 may generate an enrollment compliance report 435 to influence future enrollment strategies. Periodically, the system may automatically verify and update the physician's contact information 440 and continued participation in the medical safety information notification process.

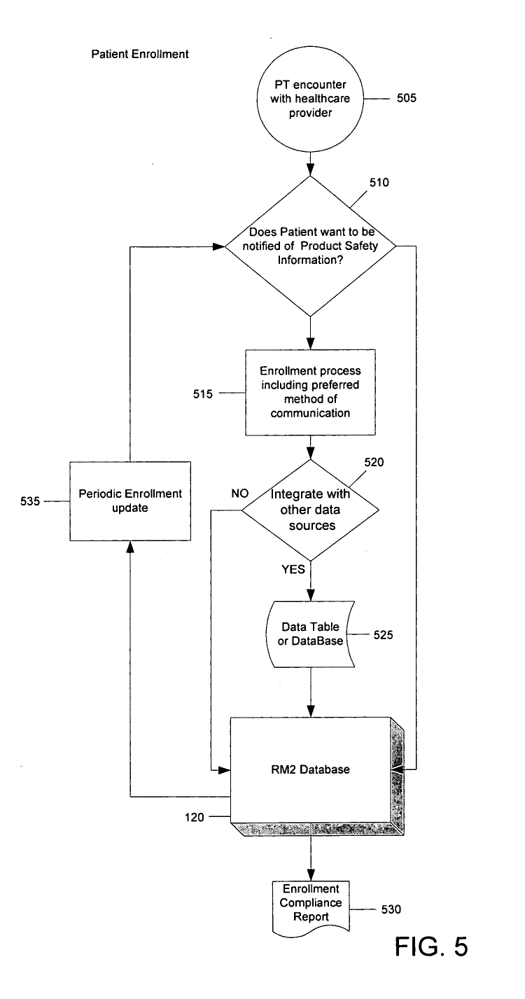

FIG. 5 depicts an exemplary method for enrolling a patient with a medical safety information system according to an embodiment. In an encounter 505 between the health care provider and the patient, such as during an office visit, the health care provider may query 510 the patient as to whether the patient would like to receive product safety updates from an independent organization. If the patient elects to receive such information, the patient may complete 515 a patient consent form, such as 300. The patient consent form may be faxed, mailed, emailed or verbally communicated via a telephone system to the medical safety information provider. Upon receipt by the medical safety information provider, the information on the patient consent form 300 may be combined with information from other data sources 520, if any, to create a database 525. The database 525 may be imported into the RM2 database 120. The RM2 database 120 may generate an enrollment compliance report 530 to influence future enrollment strategies. Periodically, the system may automatically verify and update the physician's contact information 535 and continued participation in the medical safety information notification process.

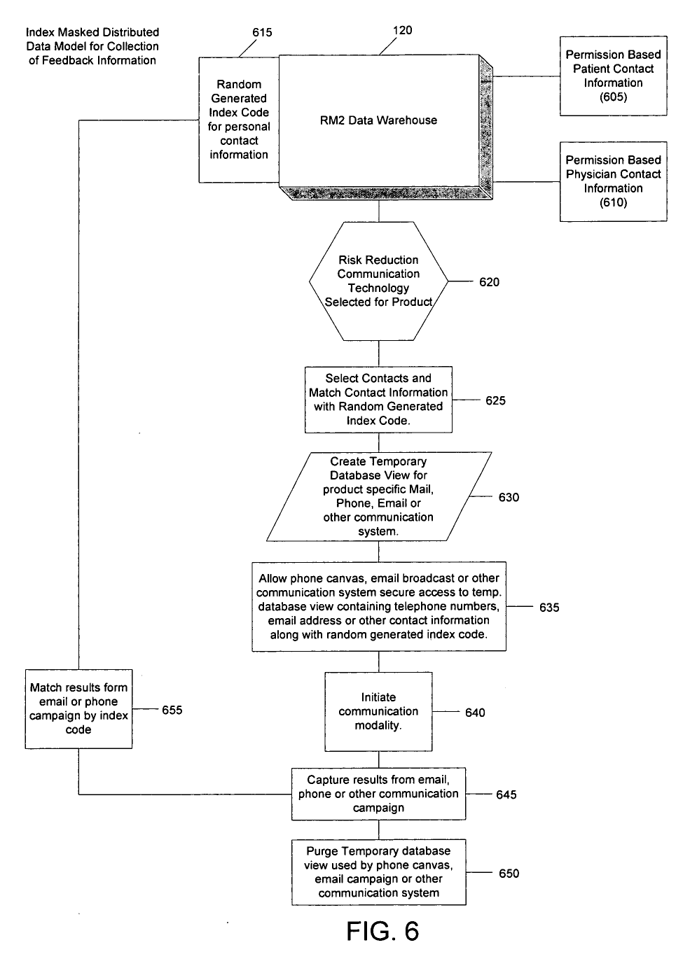

FIG. 6 depicts an exemplary method for matching medical safety information content with a health care provider or patient request for information according to an embodiment. The method depicted in FIG. 6 preserves the privacy and security of the recipient data. After the RM2 database 120 receives opt-in permission based patient contact information 605 or physician contact information 610, the RM2 database 120 may assign 615 a randomly generated index code to the contact information. Based on the distribution technology (i.e., phone, fax, Internet, etc.) selected for risk reduction information distribution 620, the RM2 database 120 may be used to select 625 the contacts to receive the information and match the contact information with one or more index codes. This may create 630 a temporary database for a product-specific risk reduction information distribution. The distribution technology may then be provided 635 with secure access to the temporary database to initiate 640 communication with and receive 645 feedback data from the listed contacts. The feedback data may be matched 650 with an index code prior to storing the data in the RM2 database 120. The RM2 database 120 may decode the data and generate reports based on the data. Finally, the temporary database may be purged 655 from the system.

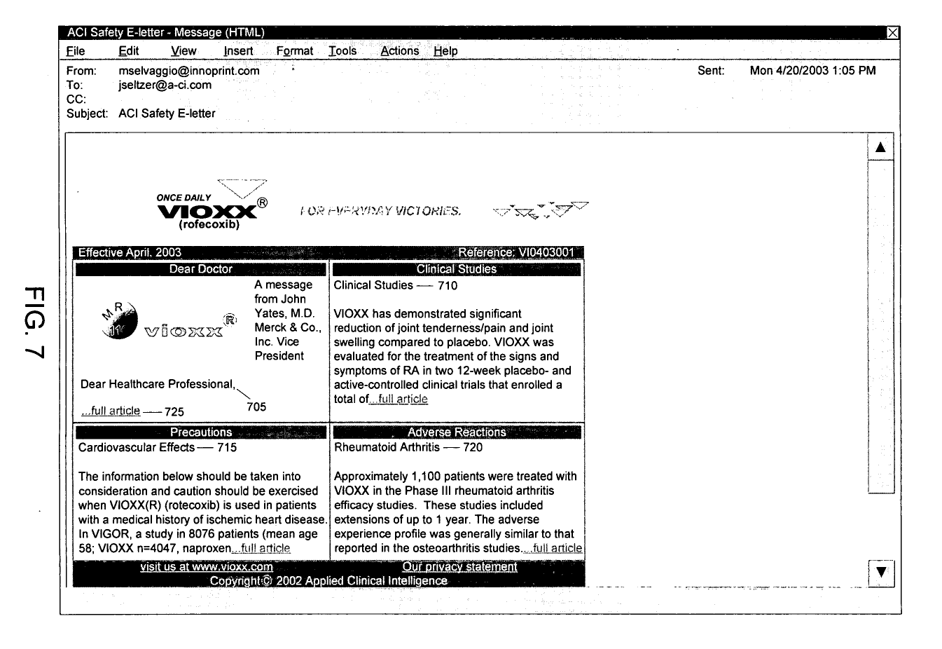

FIG. 7 depicts an exemplary email containing medical safety information according to an embodiment. In an embodiment, an email may be sent to one or more health care providers and/or patients containing medical safety information for one or more drugs or medical devices of interest. The email may contain one or more sections, such as, for example, a note from the drug or medical device provider 705, information regarding clinical studies 710, precautions related to the drug or medical device 715, and/or reported adverse reactions 720. Each section may include only a portion of an article to which it refers. In addition, each section may contain a link, such as 725, to a web page containing further information regarding the particular topic. Feedback data may be obtained by determining whether each intended recipient opened the email, noting the number of times a particular article is accessed by clicking on its link from the email, and the like. Such information may be stored in the RM2 database 120 for statistical analysis.

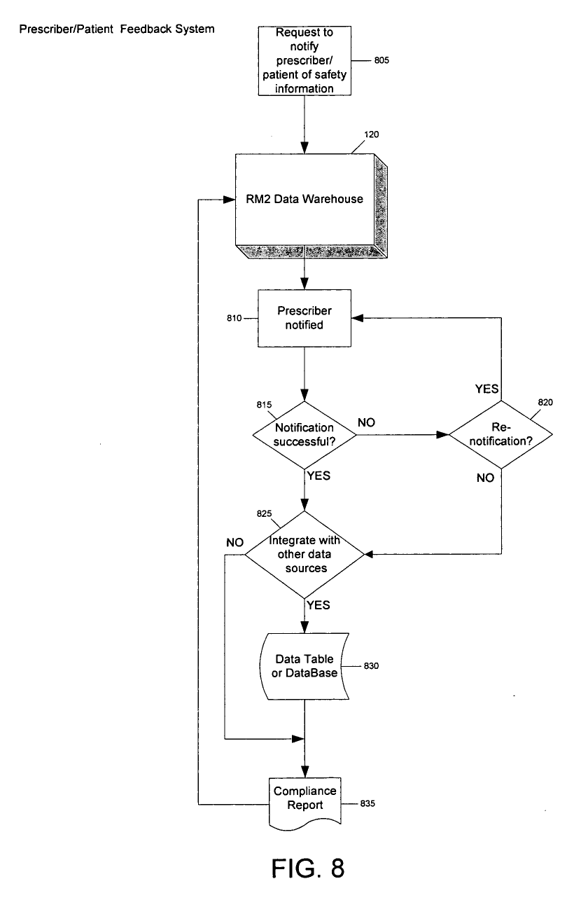

FIG. 8 depicts an exemplary method of providing feedback to the medical safety information system from a health care provider or patient according to an embodiment. A request to notify a patient or prescriber regarding medical safety information may be submitted 805 to the RM2 database 120. The RM2 database 120 may notify 810 the patient or prescriber according to the process described above in reference to FIG. 6. Optionally, the patient or prescriber's caregiver may be notified on behalf of the patient. A determination as to whether the notification was successful may then be made 815. If the notification was unsuccessful, a determination as to whether re-notification should be performed may be made 820. If either the notification was successful or re-notification is not required, data regarding whether notification was successful may be gathered or generated. The data may optionally be integrated 825 with data from other data sources. The integrated data may be stored in a database 830, and a compliance report may then be generated 835.

In an embodiment, a pharmaceutical company may correlate success in proper prescribing behavior obtained from vendors. This data may be integrated with the notification data. In an alternate embodiment, a physician wishing to notify and query patients regarding side effects from prescribed medication may correlate age and gender information regarding the patients with the notification and side effect information.

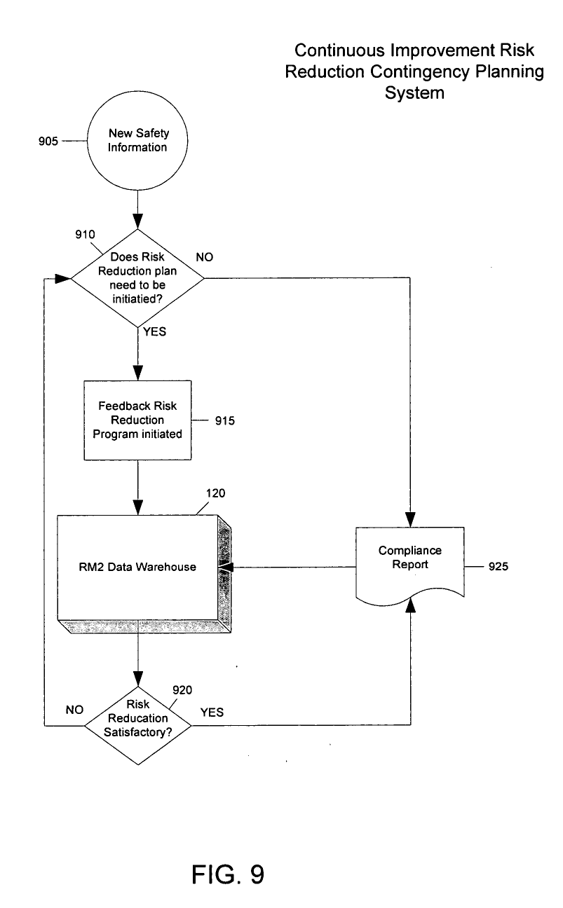

FIG. 9 depicts an exemplary method of updating the medical safety information system based on received feedback according to an embodiment. In order to improve the quality of information and the way in which it is presented, evaluation of previous efforts, redesigns and measurements may be performed. When new medical safety information is available and risk reduction information is distributed 905, such as by the process described above in reference to FIGS. 6-8, results may be automatically computed from the feedback information. If further risk reduction efforts are required 910 based on the results, the system may initiate a new risk reduction program 915. The success of various risk reduction activities may be entered into the RM2 database 120. Once sufficient data is collected, the system may use the data to predict the success of the risk reduction activities. If the risk reduction activities achieve a sufficient level of performance 920, a compliance report may be generated 925. Otherwise, a determination as to whether the system should perform additional risk reduction activities may be made 910.

In an embodiment, if a pharmaceutical company uses an email campaign to provide risk reduction information and a resulting positive change occurs in the prescribing behavior of physicians that attended East Coast medical schools, the system may launch a phone campaign at those that did not attend East Coast medical schools. If risk behavior is not reduced sufficiently, other subgroups may be targeted with direct mail or personal interventions. The results of these campaigns may further update the information in the RM2 database 120.

In an alternate embodiment, a health care provider may want to know which patients are having side effects from a medicine. The system may instruct patients to contact the physician if they experience side effects. Algorithmically, the system may continue feedback communications to and create specialized compliance reports for the physician based on the returned information. If insufficient feedback is received, alternate methods of relaying information from the patients to the health care provider may be performed.

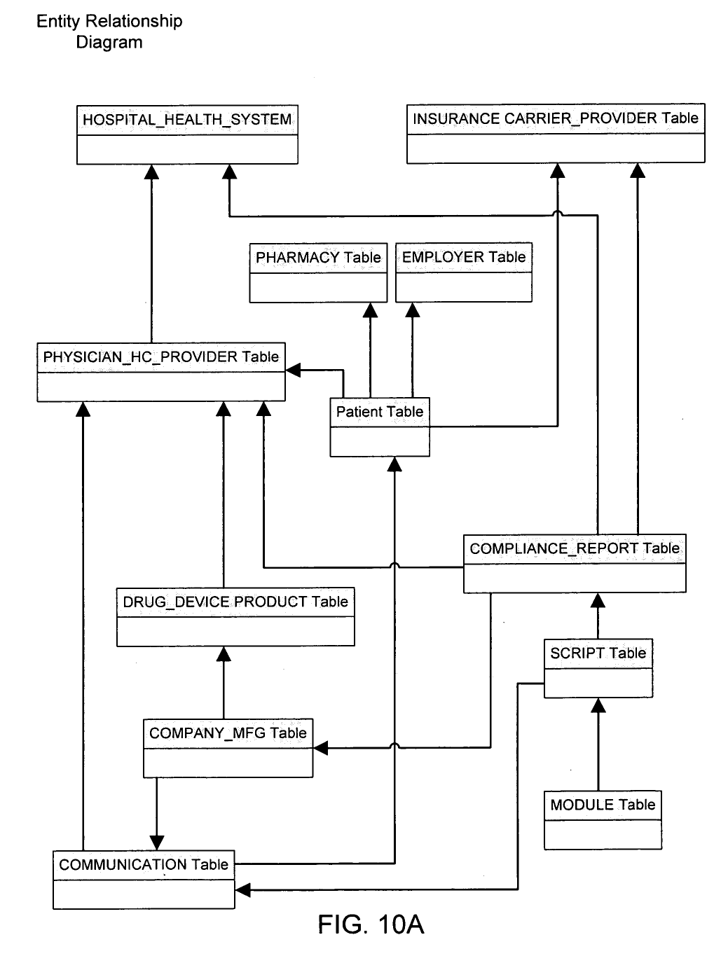

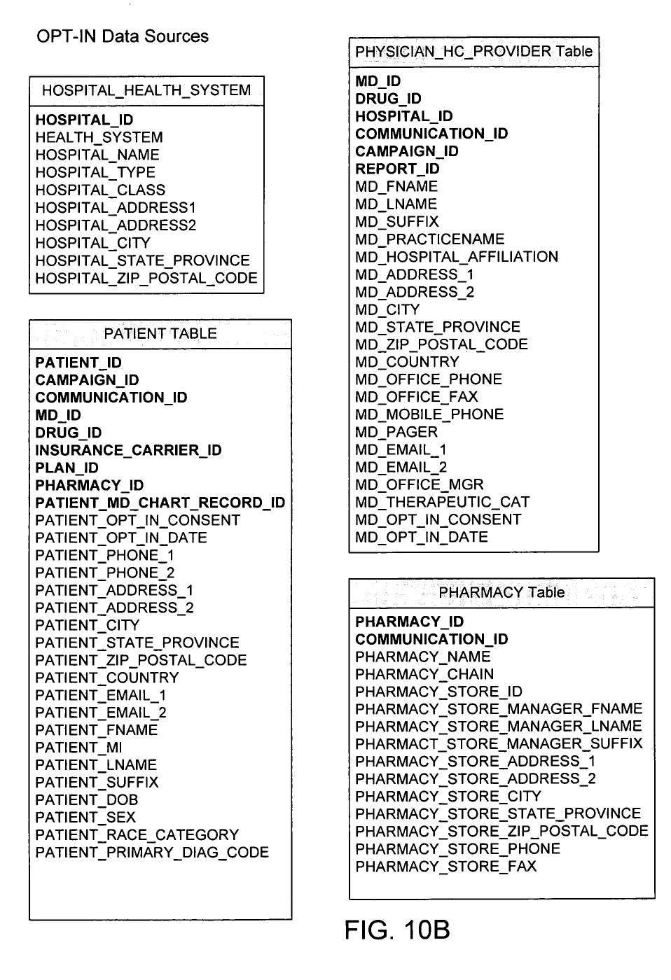

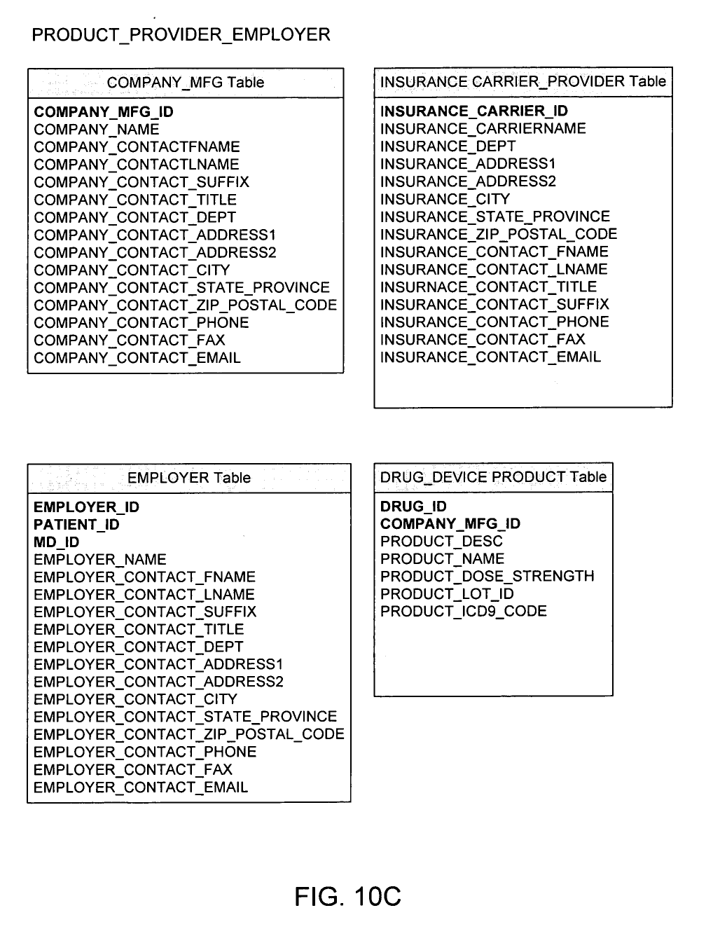

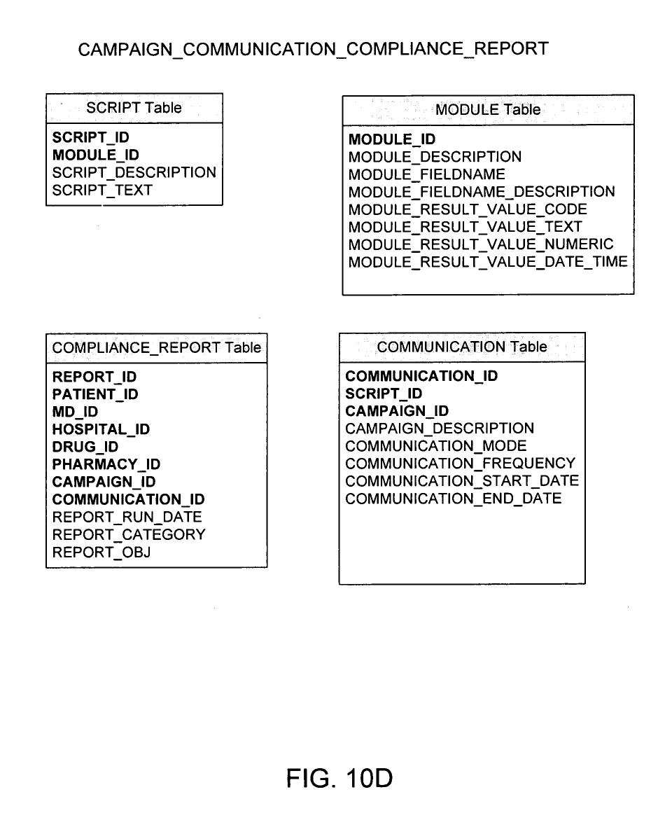

FIG. 10A depicts an exemplary entity relationship diagram for a medical safety information system according to an embodiment. The diagram displays the transfer of information from one module to another. The information may be used for the generation of reports or the provision of medical safety information to one or more entities. A description of the data types used by each of the entities is further defined in FIGS. 10B-D.

FIG. 10B represents the sources of information and the information retrieved or assigned during the consent process according to an embodiment. In the embodiment, a hospital or health system may provide, for example, one or more of a name, a type and class for the health system, and a postal address. The system may assign, for example, a health system identifier to each hospital or health system upon receipt of the consent form.

A patient may provide, for example, one or more of a consent (e.g., a signature), a date of consent, one or more phone numbers, one or more email addresses, a postal address, a name, a date of birth, a gender, a race, and a primary diagnosis code. The system may assign, for example, one or more of a patient identifier, a campaign identifier, a physician identifier based on the treating physician, a communication identifier, a drug identifier, an insurance carrier identifier, a plan identifier, a pharmacy identifier and a patient chart record identifier to each patient.

A physician or other health care provider may provide, for example, one or more of a name, a practice name, a hospital affiliation, a postal address, one or more phone numbers, one or more facsimile numbers, one or more email addresses, an office manager name, a therapeutic category, a consent and a date of consent. The system may assign, for example, one or more of a physician identifier, a drug identifier, a hospital identifier, a communication identifier, a campaign identifier and a report identifier to each physician or other health care provider.

A pharmacy may provide, for example, one or more of a name, a chain with which the pharmacy is associated, a store identifier, a name of a store manager, a postal address, one or more phone numbers and one or more facsimile numbers. The system may assign, for example, a pharmacy identifier and/or a communication identifier to each pharmacy.

FIG. 10C represents the stored data for the medical products for which medical safety information is stored, the medical product manufacturers providing such products, the employers of the patients, and the insurance carriers for the patients according to an embodiment. In the embodiment, the medical product manufacturer information may include, for example, one or more of a name of the manufacturer and a name, title, department, postal address, phone number, facsimile number and email for a contact for the manufacturer. The system may assign, for example, a manufacturer identifier to each medical product manufacturer.

The employer information may include, for example, one or more of a name for the employer and a name, title, department, postal address, phone number, facsimile number and email for a contact for the employer. The system may assign, for example, one or more of an employer identifier, one or more patient identifiers and one or more physician identifiers to each employer.

The insurance carrier information may include, for example, one or more of a name of the insurance carrier, a department, an postal address and a name, title, phone number, facsimile number and email for a contact for the insurance provider. The system may assign, for example, an insurance provider identifier to each insurance provider.

The medical product information may include, for example, one or more of a product description, a product name, a dosage strength, a lot identifier and an ICD9 code for the medical product. The system may assign, for example, a drug identifier and/or a medical device manufacturer identifier to each medical product.

FIG. 10D represents the stored information for each campaign, communication and compliance report according to an embodiment. In the embodiment, the script information may include, for example, a description and/or other text. The system may assign, for example, a script identifier and/or a module identifier to each script.

The compliance report information may include one or more of a run date, a category and an objective. The system may assign, for example, one or more of a report identifier, one or more patient identifiers, one or more physician identifiers, one or more health system identifiers, one or more drug identifiers, one or more pharmacy identifiers, a campaign identifier, and a communication identifier to each compliance report.

The module information may include, for example, one or more of, a module description, a module field name, a module field name description and a code, text, numeric value and date/time for a result value for the module. The system may assign, for example, a module identifier to each module.

The communication information may include, for example, one or more of a campaign description, a mode of communication, a frequency for communication, and start and end dates for the communication. The system may assign, for-example, one or more of a communication identifier, a script identifier and a campaign identifier to each communication.

Although the invention has been described with reference to the preferred embodiments, it will be apparent to one skilled in the art that variations and modifications are contemplated within the spirit and scope of the invention. The drawings and description of the preferred embodiments are made by way of example rather than to limit the scope of the invention, and it is intended to cover within the spirit and scope of the invention all such changes and modifications.

1. A method for distributing medical safety information, the method comprising:
maintaining a first database containing medical safety information;
maintaining a second database containing identification and preference data relating to a plurality of health care system participants;
selecting one or more health care system participants from the second database;
identifying medical safety information in the first database corresponding to the preference data of the selected health care system participants;
distributing at least a portion of the identified medical safety information to the selected health care system participants;
receiving feedback information indicative of a measure of performance for the distributing step; and
automatically determining, based on the feedback information, whether to distribute additional medical safety information to one or more of the selected health care system participants.

2. The method of claim 1 wherein the preference data comprises an identifier for a medical product.

3. The method of claim 1 wherein the health care system participants comprise one or more of health care providers, patients, and health care organizations.

4. The method of claim 1 wherein the selecting one or more health care participants comprises selecting one or more health care participants based on the preference data.

5. The method of claim 1, further comprising:
generating one or more compliance reports based on the feedback information.

6. The method of claim 1 wherein the preference data is obtained from a consent form.

7. The method of claim 1 wherein the preference data is updated based on the feedback information.

8. The method of claim 1 wherein distributing at least a portion of the identified medical safety information comprises distributing at least a portion of the identified medical safety information via one or more of the following:
a telephone system;
a computer network; and
a physical mail system.

9. The method of claim 4 wherein the identified medical safety information comprises one or more of the following:
information from a manufacturer of a medical product;
information regarding a clinical study pertaining to the medical product;
precautionary information pertaining to the medical product; and
one or more reported adverse reactions.

10. A system for distributing medical safety information, the system comprising:
a processor;
a first database containing medical safety information;
a second database containing identification and preference data relating to a plurality of health care system participants; and
a computer-readable storage medium, wherein the computer-readable storage medium contains one or more programming instructions for performing a method of distributing medical safety information, the method comprising:
selecting one or more health care system participants from the second database,
identifying medical safety information in the first database corresponding to the preference data of the selected health care system participants,
distributing at least a portion of the identified medical safety information to the selected health care system participants,
receiving feedback information indicative of a measure of performance for the distributing step, and
automatically determining, based on the feedback information, whether to distribute additional medical safety information to one or more of the selected health care system participants.

11. The system of claim 10 wherein the preference data comprises an identifier for a medical product.

12. The system of claim 10 wherein the health care system participants comprise one or more of health care providers, patients, and health care organizations.

13. The system of claim 10 wherein selecting one or more health care participants comprises selecting one or more health care participants based on the preference data.

14. The system of claim 10 wherein the computer-readable storage medium further comprises one or more programming instructions for generating one or more compliance reports based on the feedback information.

15. The method of claim 10 wherein the preference data is obtained from a consent form.

16. The method of claim 10 wherein the preference data is updated based on the feedback information.

17. The method of claim 10 wherein distributing at least a portion of the identified medical safety information comprises distributing at least a portion of the identified medical safety information via one or more of the following:
a telephone system;
a computer network; and
a physical mail system.

18. The method of claim 10 wherein the identified medical safety information comprises one or more of the following:
information from a manufacturer of a medical product;
information regarding a clinical study pertaining to the medical product;
precautionary information pertaining to the medical product; and
one or more reported adverse reactions.
